(19) United States
(12) Patent Application Publication
(10) Pub. No.: US 2006/0087581 A1
(43) Pub. Date: Apr. 27, 2006

(54) Exposure control method

(75) Inventor: Wen-Kuo Lin, Hsin Chu (TW)

Correspondence Address: TROXELL LAW OFFICE PLLC, SUITE 1404, 5205 LEESBURG PIKE, FALLS CHURCH, VA, 22041, US

(73) Assignee: Silicon Integrated Systems Corp.

(21) Appl. No.: 10/969,966

(22) Filed: Oct. 22, 2004

(51) Int. Cl. H04N 5/238; G03B 7/08; G03B 7/00

(52) U.S. Cl. 348/364; 396/237

(57) ABSTRACT

The invention describes an exposure control method. A target luminance value is set. A plurality of range and step parameters is set. An exposure value (EV) is set and an exposure value adjustment index is obtained by an adjustment based on the range and step. A new target luminance value is obtained from a table according to an adjustment factor. An measured luminance value is measured according to the exposure setting. A modified exposure value is calculated by an exposure value (EV) modification process. Thereby, basic arithmetic and logical operations, such as addition, subtraction, multiplication and division are be used in place of complicated exposure calculation using a logarithmic operation in the conventional image processor and thus problems of power consumption and execution speed are resolved.

### BACKGROUND OF THE INVENTION

1. Field of the Invention

The present invention solves problems of power consumption and execution speed in the prior art by using a basic comparison operation.

2. Description of the Related Art

In a digital camera system, exposure control is one of the important factors that contribute to the quality of a captured digital image. Other factors include white balance control and focus control. The function of an exposure control is to map a segment of the enormously wide luminance range in the real world onto a predefined digital range to mimic the brightness adaptation phenomenon of the human vision system. Precise exposure control is crucial to a digital camera system.

The ambient luminance is usually represented by intensity levels ranging from 0 to 255 (from dark to bright) in a digital camera system. Such an evenly distributed value of exposure control is referred to as an exposure value (EV), which is basically controlled by three factors including a shutter speed T, an aperture number F and a gain G, and is formulated as in Equation (1):

$$EV = {log}_{2} ( \frac{{F}^{2}}{T \times G} ) \qquad ( 1 )$$

A conventional exposure control process is illustrated in FIG. 1. First, a target luminance value Y_{target} is chosen after light is measured by a metering system in a digital camera device (step S11). Next, an initial exposure value is set by the shutter speed, the aperture number and the gain (step S12). Then, an measured luminance value Yₘₑₐₛᵤᵣₑ obtained from an object image is input (step S13). Subsequently, another exposure value (EV) is obtained by Equation (2), with the initial exposure value (EV) being a logarithmic calculation on a ratio of the measured luminance value Yₘₑₐₛᵤᵣₑ obtained from the object image to the initial target luminance value Y_{target} (step S14).

$$EV = EV + {log}_{2} ( \frac{{Y}_{measure}}{{Y}_{target}} ) \qquad ( 2 )$$

Then, it is determined whether or not the thus obtained exposure value is a new exposure value different from the initial exposure value (step S15). If the exposure value is changed, then it is set to a new exposure value (step S16) and the exposure control process is repeated with this new exposure value. If the exposure value is unchanged, then a final EV is obtained and the exposure control process terminates.

However, the conventional exposure control process requires a logarithmic calculation, which involves complicated instructions and thus it is not always feasible to implement such circuit in a simple controller or a microprocessor, for example, in portable consumer electronic devices, such as mobile phones and digital cameras. In addition, such a complicated circuit consumes more power and the execution speed thereof is slow.

### SUMMARY OF THE INVENTION

The present invention provides an exposure control method, in which basic arithmetic and logical operations, such as addition, subtraction, multiplication and division, are used in place of the complicated logarithmic calculation to obtain an exposure value for an image processor. In addition, problems of power consumption and execution speed can be resolved.

According to one aspect of the invention, the method comprises the steps of: setting a target luminance value; setting comparison conditions; enabling exposure compensation to adjust the target luminance value; setting a first exposure value; inputting a measured luminance value of an object image; performing a comparison operation to compare the measured luminance value and the target luminance value; and obtaining a second exposure value and terminating the exposure control if the exposure value is not required to be changed after repeating the comparison operation.

The exposure value modification process comprises the steps of: calculating a luminance threshold; adjusting the luminance threshold by gradually varying the range index and the step index and comparing the adjusted luminance threshold with the target luminance value; calculating the modified exposure value and obtaining a flag signal; and limiting the modified exposure value between a maximum exposure value and a minimum exposure value.

### BRIEF DESCRIPTION OF THE DRAWINGS

Features and advantages of the present invention will be fully understood from the detailed description to follow taken in conjunction with the embodiments as illustrated in the accompanying drawings, which are to be considered in all respects as illustrative and not restrictive, wherein:

FIG. 1 illustrates a conventional exposure control process;

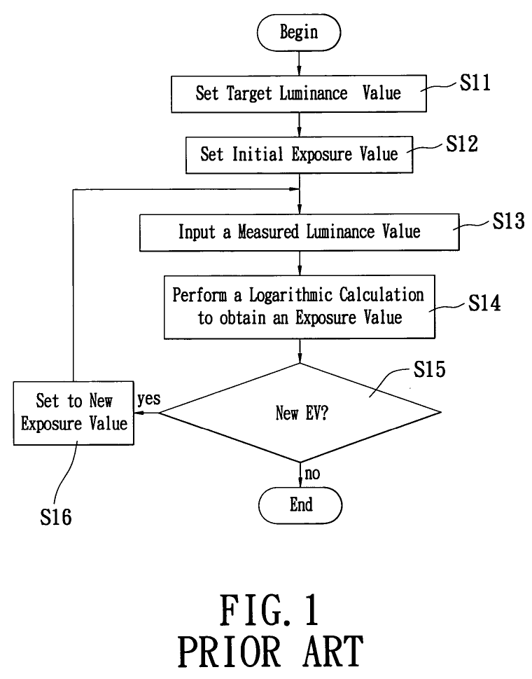

FIG. 2 is a flowchart showing an exposure control process of the present invention;

FIG. 3 is a flowchart of an exposure control method according to a first embodiment of the present invention;

FIG. 4 is a flowchart of an exposure value (EV) modification process in the exposure control method according to the present invention;

FIG. 5 is a flowchart of a first EV modification process in the exposure control method according to the present invention;

FIG. 6 is a flowchart of a second EV modification process in the exposure control method according to the present invention;

FIG. 7 is a flowchart of an exposure control method according to a second embodiment of the present invention; and

FIG. 8 is a flowchart of an EV modification process in the exposure control method according to the second embodiment of the present invention.

### DETAILED DESCRIPTION OF PREFERRED EMBODIMENTS

To improve the complicated calculation in the prior art, the invention provides an improved exposure control method for a processor that is only capable of performing basic arithmetic and logical operations, such as addition, subtraction, multiplication and division. Specifically, a simple comparison operation is employed to achieve the same performance as the conventional logarithmic calculation in obtaining an exposure value.

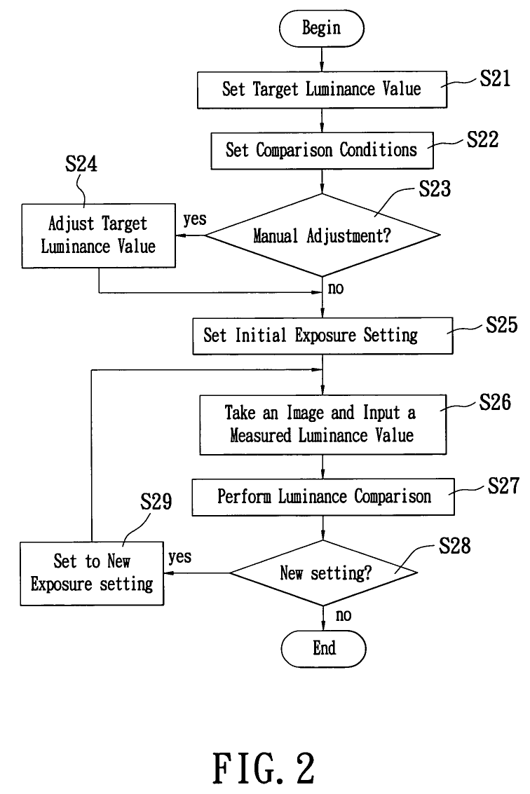

Reference is made to FIG. 2, which is a flowchart showing an exposure control process of the present invention.

First, a target luminance value is set (step S21).

Next, comparison conditions are set (step S22).

Then, it is determined whether or not a manual adjustment is required (step S23). If exposure compensation is enabled, then the target luminance value needs to be adjusted. This adjustment can be done manually.

If an adjustment is required, the process then adjusts the target luminance value is then adjusted (step S24).

After the adjustment or in the case where no adjustment is required, a set of initial exposure settings is set to the exposure control system (step S25).

An image is then taken corresponding to the exposure setting and a luminance value measured from the image is input (step S26).

Then, the measured luminance value is compared to the manually-adjusted target luminance value (step S27).

Whether there is a need for a new exposure setting is determined according to the comparison result. (step S28)

If there is a need for new exposure setting, then a new exposure setting is set to the exposure control system (step S29), and the control process returns to step S26

If the exposure value becomes stabilized through the above steps the exposure control process is terminated.

Since only a comparison operation is employed in the above exposure control process, arithmetic complexity to implement the present invention is significantly lower than the conventional logarithmic process and therefore is suitable for implementation either in a simple digital microprocessor or in an application-specific integrated circuit (ASIC).

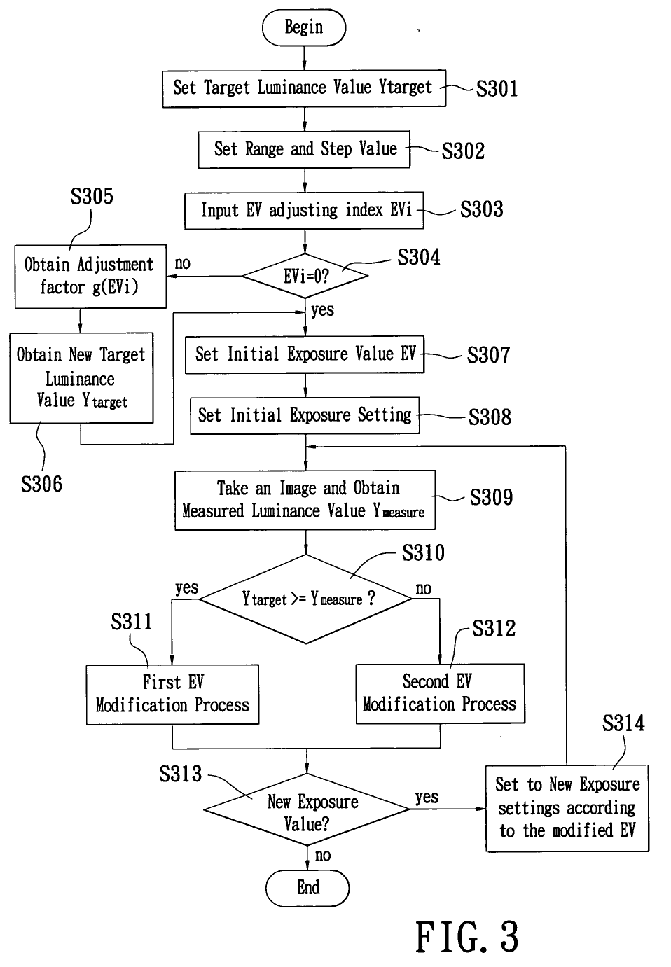

FIG. 3 illustrates a best embodiment of the above exposure control method according to the present invention.

First, a target luminance value Y_{target} is set and all condition parameters for luminance comparison are chosen (step S301).

The parameters include a plurality of range values and step values, where range values are used to determine the convergence speed of an exposure control system and step values are used to determine the convergence accuracy of an exposure control system. In this embodiment, the range values are Range1 and Range2, and the step values are Step1 and Step2. These values are set to predetermined values in step S302.

After that an exposure value (EV) adjusting index EVi is obtained through an user interface. (step S303).

If EVi is not 0, an exposure compensation process is required.

The exposure compensation process is performed by retrieving an adjustment factor g(EVi) from a table and the by adjusting the target luminance value Y_{target} is calculated by Equation (3). In Equation (3), the index Evi can be either negative or positive, and the value of Evi is normally a multiple of step value step1 or step2 in a limited range value. Furthermore, the values of g(EVi) are obtained from empirical results and stored in a table.
Y_{target}=Y_{target}×g(EVi) (3)

If EVi is 0, the exposure compensation process is not required for the target exposure value, and the process is moved to step S307. In step S307, an initial EV is chosen and according to the chosen EV a set of exposure settings are retrieved from a table. Those settings are then set to the exposure system (S308). In this embodiment, exposure control factors at least include a shutter speed T, an aperture number F, an analog gain AG and a digital gain DG (step S308), and the corresponding EV can therefore be calculated by Equation (4).

$$EV = {log}_{2} ( \frac{{F}^{2}}{T \times AG \times DG} ) \qquad ( 4 )$$

Furthermore, the table storing the exposure settings has a plurality of setting combinations corresponding to different EVs and is predetermined according to the control factors the speed of exposure convergence and the accuracy of the exposure control.

In step S309, a measured luminance value Yₘₑₐₛᵤᵣₑ is measured from an image taken by the exposure settings in step S308. The object image may be of an luminance-chrominance color format, such as YUV, or an RGB color format which in turn gives Yₘₑₐₛᵤᵣₑ by Yₘₑₐₛᵤᵣₑ=C₁*Rₘₑₐₛᵤᵣₑ+C₂*Gₘₑₐₛᵤᵣₑ+C₃*Bₘₑₐₛᵤᵣₑ and C₁+C₂+C₃=l (step S309).

Then, the target luminance value and the measured luminance value are compared with each other to determined whether or not the target luminance value is greater than or equal to the measured luminance value (Y_{target}>=Yₘₑₐₛᵤᵣₑ?) (step S310).

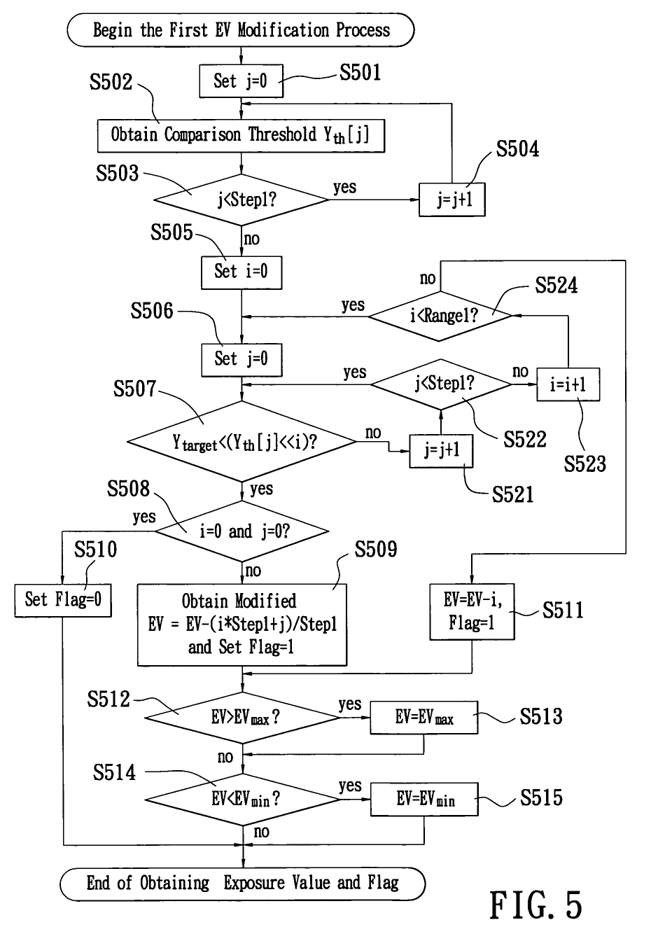

If the target luminance value is greater than or equal to the measured luminance value, then a first exposure value (EV) modification process as described with reference to FIG. 5 is performed (step S311).

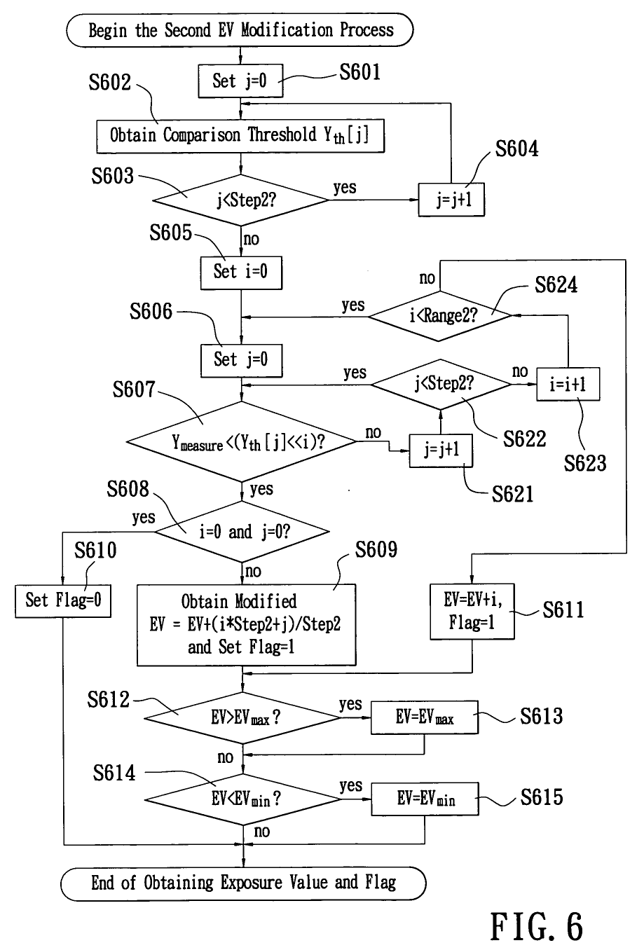

If the target luminance value is smaller than the measured luminance value, then a second EV modification process as described with reference to FIG. 6 is performed (step S312).

A modified exposure value and a flag signal Flag will be obtained from either EV modification process. The flag signal, either 0 or 1, is used to indicate whether or not the exposure value is modified and in turn a new set of exposure control settings is to be set to the system according to the modified exposure valve (step S313).

That is, if it is determined from the flag signal Flag=1, then there is a need to set a new set of exposure control settings according to the modified exposure and the process returns to step S309 to obtain a new measured luminance value (step S314).

Whereas, if the flag signal Flag=0, then the exposure control system is stabilized so the control process terminates.

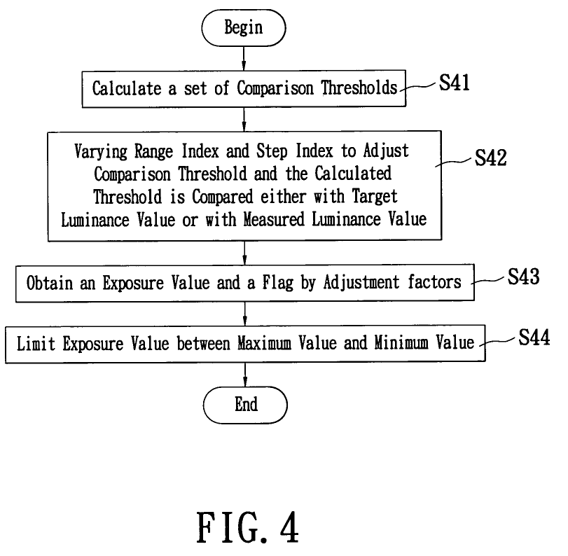

In the case where an EV modification process is required after the step of comparing the target luminance value and the measured luminance value in step S310 of FIG. 3, a set of comparison thresholds is firstly acquired as shown in FIG. 4 (step S41). Next, the range index “i” and the step index “j” are changed stepwise to adjust comparison thresholds. Then, either the target luminance value or the measured illumination value is compared with the calculated thresholds (step S42). Subsequently, a modified exposure value and a flag signal are obtained by the adjustment factors including the range index “i”, the step index “j”, the original exposure value EV and the step value Step1 (step S43). The modified exposure value is limited between a maximum exposure value and a minimum exposure value specified by the system (step S44). Embodiments of this EV modification process will be explained below with reference to FIGS. 5 and 6.

As described in the process of FIG. 3, if the target luminance value is greater than or equal to the measured luminance value (Y_{target}>=Yₘₑₐₛᵤᵣₑ), then the luminance should be changed from dark to bright and a set of thresholds should be obtained from the measured luminance value. Therefore, a first exposure value (EV) modification process is carried out to achieve the above purpose. In the embodiment shown in FIG. 5, the set of thresholds is adjusted stepwise based on the first range value Range1 and the first step value Step1.

As the first EV modification process begins, an initial condition is set to step index j=0 (step S501).

With the initial condition and the measured luminance value Yₘₑₐₛᵤᵣₑ, a comparison threshold is calculated by Yₜₕ[j]=Yₘₑₐₛᵤᵣₑ*a[j], where a[j] is an adjustment factor (step S502). The first step value Step1 defines an interval between steps and is one of the control parameters for this process (step S503).

After that, if the index “j” is smaller than the first step value Step1 (S503), then the step index “j” is increased by 1 (j=j+1) (step S504), and the threshold calculation process returns to step S502.

Whereas, if the index “j” is not smaller than the first step value Step1, then enough comparison thresholds have been obtained and the process advances to the next step. In the next step, the target luminance value Y_{target} is compared to the calculated comparison thresholds Yₜₕ. At the beginning, the range index “i” is set to i=0, indicating the comparison is performed in the first range (step S505). Also, the step index “j” is set to j=0 (step S506).

Then, the target luminance value Y_{target} is compared to the adjusted luminance threshold as Y_{target}<(Yₜₕ[j]<<i), where the symbol “<<” represents a logic left-shift operation for adjusting the threshold according to the range index “i” (step S507).

If the comparison result is not true (that is, if the target luminance value Ytarget is greater than or equal to the threshold), then the step index “j” is increased by 1, i.e., j=j+1 (step S521).

After that, if the new step index “j” is still smaller than the first step value Step1 (step S522), then the process returns to step S507 and the target luminance value is compared with the next shifted luminance thresholdYₜₕ[j].

However, if the step index “j” is not smaller than the first step value Step1, then the range index “i” is increased by 1, i.e., i=i+1, to adjust the range (step S523).

Then, the range index “i” is compared with the first range value Range1 to determine whether the range index “i” is smaller than the first range value Range1 (step S524). If the range index “i” is smaller than the first range value Range1, the process advances to step S506, and the step index “j” is set to 0. On the other hand, if the range index “i” is not smaller than the first range value Range1, then the exposure value EV is obtained by EV=EV−i and the flag signal Flag is set to 1 (step S511).

In the above step S507, if the target luminance value Y_{target} is smaller than the shifted luminance threshold, then whether or not the range index “i” and the step index “j” are both 0 is determined (step S508).

If the range index “i” and the step index “j” are both 0, then there is no need to modify the exposure value and therefore the flag signal Flag is set to “0” to indicate that the exposure value does not require any modification and the original exposure value can be adopted (step S510).

Whereas, if either the range index “i” or the step index “j” is not 0, then a modified exposure value EV is obtained by Equation (5) and the flag signal Flag is set to 1 (step S509).

$$EV = EV - \frac{i \times Step1 + j}{Step1} \qquad ( 5 )$$

After the above steps, in the case when the flag signal flag is set to 1, the modified exposure value is further compared with the maximum exposure value and the minimum exposure value of the system. This comparison process is to limit the exposure value between the maximum and the minimum exposure values to prevent an improper exposure result. That is, if the exposure value EV is greater than the maximum exposure value EVₘₐₓ (S512), the exposure value EV is set to EVₘₐₓ (S513). While if the exposure value EV is smaller than the minimum exposure value EVₘᵢₙ (S514), the exposure value EV is set to EVₘᵢₙ (S515).

Finally, a modified exposure value EV and a flag signal for the exposure control system of this invention are both obtained by the first EV modification process.

As described in the process of FIG. 3, if the target luminance value is smaller than the measured luminance value (Y_{target}<Yₘₑₐₛᵤᵣₑ), then the luminance should be changed from bright to dark and a set of threshold should be obtained from the target luminance value Y_{target}. Therefore, a second exposure value (EV) modification process is performed. In the embodiment shown in FIG. 6, which is different from the process in FIG. 5, the threshold is adjusted stepwise based on the second range value Range2 and the second step value Step2.

As the second EV modification process begins, the step index j is set to 0 (step S601) and the target luminance value Y_{target} is used to calculate the comparison threshold as Yₜₕ[j]=Y_{target}*a[j], where a[j] is an adjustment factor (step S602). The second step value Step2 defines an interval between steps and is not necessarily the same as the above-mentioned first step value Step1 (step S603).

After that, if the index “j” is smaller than the second step value Step2, then the step index “j” is increased by 1 (j=j+1) (step S604) and the process returns to step S602 to obtain another threshold.

Whereas, if the index “j” is not smaller than the second step value Step2, then enough comparison thresholds have been generated and the process advances to the next step. In the next step the measured luminance value Yₘₑₐₛᵤᵣₑ is compared to the calculated comparison threshold Yₜₕ. At the beginning, the range index “i” is set to i=0, indicating the comparison is performed in the first range (step S605).

Also, the step index “j” is set to j=0 (step S606).

Then, the measured luminance value Yₘₑₐₛᵤᵣₑ is compared to the adjusted luminance threshold as Yₘₑₐₛᵤᵣₑ<(Yₜₕ[j]<<i), where the symbol “<<” represents a logic left-shift operation for adjusting the threshold according to the range index i (step S607).

If the comparison result is not true (that is, if the measured luminance value Yₘₑₐₛᵤᵣₑ is greater than or equal to the threshold), then the step index “j” is further increased by 1, i.e., j=j+1 (step S621).

After that, if the new step index “j” is still smaller than the second step value Step2 (step S622), then the process returns to step S607 and the measured luminance value is compared with the next shifted luminance threshold.

However, if the step index “j” is not smaller than the second step value Step2, then the range index “i” is increased by 1, i.e., i=i+1 (step S623).

Then, the range index “i” is compared with the second range value Range2 to determine whether the range index “i” is smaller than the second range value Range2 (step S624). If the range index “i” is smaller than the second range value Range2, then the process advances to step S606 and the step index “j” is set to 0. On the other hand, if the range index “i” is not smaller than the second range value Range2, then the exposure value is obtained by EV=EV+i and the flag signal Flag is set to 1 (step S611).

In the above step S607, if the measured luminance value Yₘₑₐₛᵤᵣₑ is smaller than the shifted luminance threshold, then whether or not the range index “i” and the step index “j” are both 0 is tetermined (step S608).

If both range index i=0 and step index j=0, then there is no need to modify the exposure value and therefore the flag signal Flag is set to “0” to indicate that the exposure value does not require any modification and the original exposure value can be adopted (step S610).

However, if either the range index “i” or the step index “j” is not 0, then a modified exposure value EV is obtained by Equation (6) and the flag signal Flag is set to 1 (step S609).

$$EV = EV + \frac{i \times Step2 + j}{Step2} \qquad ( 6 )$$

After the above steps, in the case when the flag signal Flag is set to 1, the modified exposure value is further compared with the maximum exposure value and the minimum exposure value of the system. This comparision process is to limit the exposure value between the maximum and the minimum values to prevent an improper exposure result. This is, if the exposure value EV is greater than the maximum exposure value EVₘₐₓ (step S612), then the exposure value EV is set to EVₘₐₓ (S613).

While if the exposure value EV is smaller than the minimum exposure value EVₘᵢₙ (S614), then the exposure value EV is set to EVₘᵢₙ (step S615).

Finally, a modified exposure value EV and a flag signal Flag for the exposure control system of this invention are both obtained by the second EV modification process.

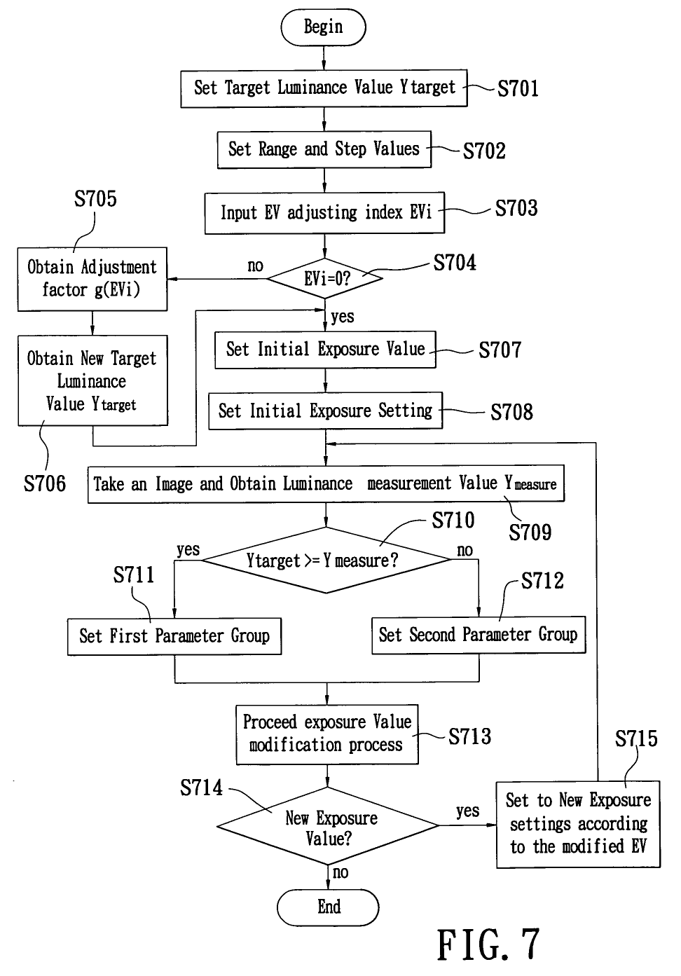

FIG. 7 shows the flowchart of a second embodiment of the exposure control method according to the present invention. In this embodiment, the control parameters the first range value Range1, the second range value Range2, the first step value Step1 and the second step value Step2 disclosed in the previous embodiment are replaced with a single range value Range and a single step value Step to simplify the exposure control process. This is, Range=Range1=Range2 and Step=Step1=Step2.

First, a target luminance value Y_{target} is set to a proper value (step S701) and the range value Range and the step value Step are set to corresponding predetermined constant values (S702)

The range value Range is used to determine the convergence speed of an exposure control system and the step value Step is used to determine the convergence accuracy of an exposure control system.

After that an exposure value (EV) adjusting index EVi is obtained through an user interface (step S703).

If EVi is not 0, an exposure compensation process is required The exposure compensation process is performed by retriving an adjustment factor g(EVi) from a table, and then by adjusting the target luminance value Y_{target} by Equation (7) (step S706).
Y_{target}=Y_{target}×g(EVi) (7)

In Equation (7), the index EVi can be either negative or positive, and the value of EVi is normally a multiple of step value Step in a limited range value. Furthermore, the values of g(EVi) are obtained from empirical resulted and are stored in a table.

However, if EVi is equals to 0, the exposure compensation process is not required and the exposure control process is moves to Step S707. In step S707 an initial EV is chosen and according to the chosen EV a set of exposure settings are retrived from a table. Those settings are then set to the exposure system (S708).

In this embodiment, exposure control factors at least include a shutter speed T, an aperture number F, an analog gain AG and a digital gain DG (step S708) and the corresponding EV can therefore be calculated by Equation (8)

$$EV = {log}_{2} ( \frac{{F}^{2}}{T \times AG \times DG} ) \qquad ( 8 )$$

Furthermore, the table storing the exposure settings has a plurality of setting combinations corresponding to different EVs and is pre-determined according to the control factors, the speed of exposure convergence and the accuracy of the exposure control.

In step S709, a measured luminance value Yₘₑₐₛᵤᵣₑ is measured From an image taken by the exposure settings in step S708.

Then, the target luminance value and the measured luminance value are compared with each other to determined whether or not the target luminance value is greater than or equal to the measured luminance value (Y_{target}>=Yₘₑₐₛᵤᵣₑ?) (step S710).

If the target luminance value is greater than or equal to the measured luminance value (Y_{target}>=Yₘₑₐₛᵤᵣₑ), then a first group of parameters is set as follows: the first luminance parameter Yₐ=the measured luminance value (Ya=Yₘₑₐₛᵤᵣₑ), the second luminance parameter Y_{b}=the target luminance value Y_{target}, and the sign parameter Sign=−1 (step S711).

On the other hand, if the target luminance value Y_{target} is smaller than the measured luminance value Yₘₑₐₛᵤᵣₑ (Y_{target}<Yₘₑₐₛᵤᵣₑ), then a second group of parameters is set as follows: the first luminance parameter Yₐ=the target luminance value Y_{target}, the second luminance parameter Y_{b}=the measured luminance value Yₘₑₐₛᵤᵣₑ, and the sign parameter Sign=+1 (step S712).

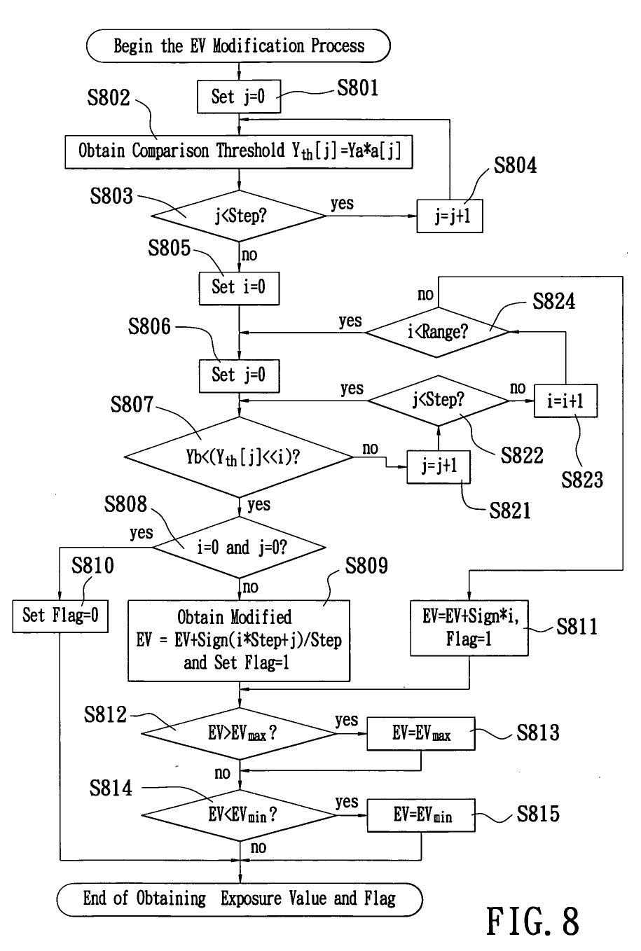

After that, an exposure value (EV) modification process as described with reference to FIG. 8 is performed (step S713).

A modified exposure value and a flag signal Flag will be obtained from the EV modification process. The flag signal, which is either 0 or 1, is used to indicate whether or that there is a new exposure value (step S714).

If the flag signal Flag equals to 1, then there is a need to set a new set of exposure control settings according to the modified exposure value and then the process returns to step S709 to obtain a new measured luminance value (step S715).

However, if the flag signal Flag equals to 0, then the exposure control system is stablized so the control process terminates.

The EV modification process in step S713 of the second embodiment is shown in FIG. 8.

As the EV modification process begins, the step index j is set to 0 (step S801) and a comparison threshold is calculated by Yₜₕ[j]=Ya*a[j], where a[j] is an adjustment factor and Ya is determined in either step S711 or S712 of FIG. 7 (step S802).

After that, if the index “j” is smaller than the step value Step, then the step index “j” is increased by 1 (j=j+1) (step S804) and the process returns to step S801 to obtain another threshold.

Whereas, if the index “j” is not smaller than the step value Step, then enough comparison thresholds have been generated and the process advances to the next step. In the next step,the measured luminance value Yb (Yb is determined in either step S711 or step S712 of FIG. 7) is compared to the calculated comparison thresholds Yₜₕ. At the beginning, the range index “i” is set to i=0, indicating the comparison is performed in the first range (step S805).

Also, the step index “j” is set to j=0 (step S806).

Then, the value Yb is compared to the adjusted luminance threshold as Y_{target}<(Yₜₕ[j]<<i), where the symbol “<<” represents a logic left-shift operation for adjusting the threshold according to the range index i (step S807).

If the comparison result is not ture (that is, if the measured luminance value Y_{b} is greater than or equal to the threshold), then the step index “j” is further increased by 1, i.e., j=j+1 (step S821).

After that, if the new step index “j” is still smaller than the step value Step (step S822), then the process returns to step S807 and Y_{b} is compared with the next shifted luminance threshold.

However, if the step index “j” is not smaller than the step value Step, then the range index “i” is increased by 1, i.e., i=i+1.

Then, the range index “i” is compared with the range value Range to determine whether the range index “i” is smaller than the range value Range (step S824). If the range index “i” is smaller than the range value Range, the process advances to step S806, and the step index “j” is set to 0 if the range index “i” is not smaller than the range value Range, then the exposure value EV is obtained by setting EV=EV+Sign*i (the parameter Sign is determined in either step S711 or step S712 of FIG. 7, and Sign=−1,+1) and the flag signal Flag is set to 1 (step S811).

In the above step S807, if Yb is smaller than the shifted luminance threshold, then whether or not the range index “i” and the step index “j” are both 0 is determined (step S808).

If both range index i=0 and step index j=0, then there is no need to modify the exposure value and thus flag signal Flag is set to 0 to indicate that the exposure value does not require any modification and the original exposure value can be adopted (step S810);

However, if either the range index “i” or the step index “j” is not 0, then a modified exposure value EV is obtained by Equation (9) and the flag signal Flag is set to 1 (step S809).

$$EV = EV + Sign \times \frac{i \times Step + j}{Step} \qquad ( 9 )$$

After the above steps, in the case when the flag signal Flag is set to 1, the modified exposure value is further compared with the maximum exposure value and the minimum exposure value of the system. This comparison process is to limit the exposure value between the maximum and the minimum values to prevent an improper exposure result. That is, if the exposure value EV is greater than the maximum exposure value EVₘₐₓ (step S812), the exposure value EV is set to Eₘₐₓ (S813)

While if the exposure value EV is smaller than the minimum exposure value EVₘᵢₙ (S814), then the exposure value EV is set to EVₘᵢₙ (step S815).

Finally, a modified exposure value EV and a flag signal Flag for the exposure control system of this invention are both obtained by the EV modification process.

In summary, the exposure control method of the present invention is advantageous in obtaining an exposure value by only basic arithmetic and logical operations to eliminate the use of complicated logarithmic operations in an exposure control system.

While the present invention has been described with reference to the detailed description and the drawings of the preferred embodiments thereof, it is to be understood that the invention should not be considered as limited thereby. Various modifications and changes could be conceived of by those skilled in the art without departuring from the scope of the present invention, which is indicated by the appended claims.

What is claimed is:

1. An exposure control method, comprising the steps of
setting a target luminance value;
setting comparison conditions;
enabling an exposure compensation to adjust said target luminance value;
setting a first exposure value;
inputting an measured luminance value of an object image;
performing a comparison operation to compare said measured luminance value and said target luminance value; and
obtaining a second exposure value and terminating the exposure control if the exposure value does not need to be changed after repetition of said comparison operation.

2. The exposure control method of claim 1, wherein in the step of adjusting said target luminance value, said target luminance is adjusted manually.

3. The exposure control method of claim 1, wherein in the step performing a comparison operation to compare said measured luminance value and said target luminance value, whether a new exposure setting is needed is determined.

4. The exposure control method of claim 1, wherein in the step of performing a comparison operation to compare said measured luminance value and said target luminance value, whether a new exposure setting is required for the comparison operation is determined.

5. An exposure control method, comprising the steps of
setting a target luminance value;
setting a plurality of range and step parameters;
setting an exposure value and obtaining an exposure value adjustment index by an adjustment based on said range and said step;
measuring an measured luminance value;
comparing said target luminance value with said measured luminance value;
performing an exposure value (EV) modification process; and
obtaining a modified exposure value and a flag signal.

6. The exposure control method of claim 5, wherein said EV modification process comprises the steps of:
calculating a set of luminance thresholds;
adjusting said luminance threshold by gradually varying said range index and said step index and comparing said adjusted luminance threshold with either said target luminance value or said measured luminance value;
calculating said modified exposure value and obtaining said flag signal; and
limiting said modified exposure value between a maximum exposure value and a minimum exposure value.

7. The exposure control method of claim 5, wherein said range and said step are used to define modification capability of said exposure value and said range and said step are not constant.

8. The exposure control method of claim 5, wherein a new target luminance value is obtained from a table according to an adjustment factor if said EV adjusting index is not 0.

9. The exposure control method of claim 5, wherein said flag signal is either 0 or 1 to indicate whether said measured luminance value needs to be re-measured to obtain a new exposure value.

10. The exposure control method of claim 5, wherein in the step of comparing said target luminance value with said luminance threshold, if said target luminance value is greater than or equal to said measured luminance value, then said exposure value (EV) of said EV modification process is calculated by
$$EV = EV - \frac{i \times Step1 + j}{Step1} ,$$
where i is a range index of said range, Step1 is a step value of said plurality of steps and j is a step index of said step.

11. The exposure control method of claim 5, wherein in the step of comparing said luminance measurement value with said luminance threshold, if said target luminance value is smaller than said measured luminance value, then said exposure value (EV) of said EV modification process is calculated by
$$EV = EV + \frac{i \times Step2 + j}{Step2} ,$$
where i is a range index of said range, Step2 is a step value of said plurality of steps and j is a step index of said step.

12. An exposure control method, comprising the steps of
setting a target luminance value;
setting a plurality of range and step parameters;
setting an exposure value and obtaining an exposure value adjustment index by an adjustment based on said range and said step;
measuring an measured luminance value;
comparing said target luminance value with said measured luminance value;
setting a parameter group;
performing an exposure value (EV) modification process; and
obtaining a modified exposure value and a flag signal.

13. The exposure control method of claim 12, wherein said EV modification process comprises the steps of:
calculating a set of luminance threshold by using a first luminance parameter from said parameter group;
adjusting said luminance thresholds by gradually varying a range index of said range and a step index of said step and comparing said adjusted luminance threshold with a second luminance parameter from said parameter group;
calculating said modified exposure value and obtaining said flag signal; and
limiting said modified exposure value between a maximum exposure value and a minimum exposure value.

14. The exposure control method of claim 12, wherein said parameter group includes a first luminance parameter, a second luminance parameter and a sign parameter, and in the step of comparing said target luminance value with said measured luminance value, if said target luminance value is greater than or equal to said measured luminance value, then said first luminance parameter is set to said measured luminance value, said second luminance parameter is set to said target luminance value and said sign parameter is set to −1.

15. The exposure control method of claim 12, wherein said parameter group includes a first luminance parameter, a second luminance parameter and a sign parameter, and in the step of comparing said target luminance value with said measured luminance value, if said target luminance value is smaller than said measured luminance value, then said first luminance parameter is set to said target luminance value, said second luminance parameter is set to said measured luminance value and said sign parameter is set to +1.

16. The exposure control method of claim 12, wherein said exposure value EV of said EV modification process is calculated by
$$EV = EV + Sign \times \frac{i \times Step + j}{Step} ,$$
where i is a range index of said range, Step is a step value of a plurality of steps, j is a step index of said step, and Sign is a sign parameter.

17. The exposure control method of claim 12, wherein said range value and said step value are used to define modification capability of said exposure value and said range and said step are not constant.

18. The exposure control method of claim 12, wherein a new target luminance value is obtained from a table according to an adjustment factor if said EV adjusting index is not 0.

19. The exposure control method of claim 12, wherein said flag signal is either 0 or 1 to indicate whether said measured luminance value needs to be re-measured to obtain a new exposure value.
